(19) United States
(12) Patent Application Publication
(10) Pub. No.: US 2007/0104856 A1
(43) Pub. Date: May 10, 2007

(54) Fish oils with an altered fatty acid profile, method of producing same and their use

(76) Inventors: Hakon Standal, Krakeroy (NO); Bjorn Skj Evestad, Bekkestua (NO); Leif A. Riege, Sarpsborg (NO)

Correspondence Address: KNOBBE MARTENS OLSON & BEAR LLP, 2040 MAIN STREET, FOURTEENTH FLOOR, IRVINE, CA, 92614, US

(21) Appl. No.: 10/556,170

(22) PCT Filed: Apr. 3, 2004
(86) PCT No.: PCT/DK04/00299

§ 371 Date: Dec. 11, 2006

Related U.S. Application Data
(60) Provisional application No. 60/467,560, filed on May 5, 2003.

(30) Foreign Application Priority Data
May 5, 2003 (DK) PA 2003 00672

(51) Int. Cl. A23L 1/325

(52) U.S. Cl. 426/643

(57) ABSTRACT

The present invention provides natural fish oils comprising altered fatty acid profiles, which are useful e.g. as a nutritional supplement. In one aspect, the invention relates to a method for obtaining such fish oils with altered fatty acid profile, in particular, oils containing nutritionally important fatty acids such as Arachidonic acid, Eicosapentaenoic acid and Docosahexaenoic acid. The method comprises the steps of (a) feeding fish a composition comprising at least one fatty acid, so as to obtain altered levels of an endogenous and/or non-endogenous fatty acid in said fish, and (b) extracting oil comprising altered levels of the at least one fatty acid from said fish. The invention further relates to a method of purifying a composition comprising at least one fatty acid by feeding a first composition to a fish and extracting a second composition comprising the at least one fatty acid from said fish. Further aspects of the invention relate to a method of preparing a triglyceride, a method of rearing fish, and use of compositions according to the invention for the preparation of a dietary supplement, a nutraceutical and/or as a food/feed additive. The invention also relates to oils obtainable by the methods of the invention, to fish comprising altered levels of Arachidonic acid, Eicosapentaenoic acid and Docosahexaenoic acid, as well as oil from a fish comprising altered levels of these fatty acids.

### FIELD OF THE INVENTION

The present invention provides natural fish oils comprising altered fatty acid profiles, which are useful e.g. as a nutritional supplement. Further, a method for obtaining such fish oils with altered fatty acid profile is provided, in particular, oils containing nutritionally important fatty acids such as Arachidonic acid (ARA C20:4n-6), Eicosapentaenoic acid (EPA C20:5 n-3) and Docosahexaenoic acid (DHA 22:6 n-3).

### BACKGROUND OF THE INVENTION

For proper development and function the human body needs supplements containing essential nutritional components such as vitamins and fatty acids. Nutritionally important fatty acids include polyunsaturated fatty acids (PUFAs) such as omega-6 and omega-3 fatty acids. Fatty acids are the building blocks of fats and oils both in our foods and in our body. They are also one of the main components of membranes that surround all cells, and they play a key part in the construction and maintenance of all cells.

Fish oil is a natural source of several of these important vitamins and fatty acids and the value of supplementing daily diet with fish oil is well established. In recent years, a particular health improving effect of omega-3 fatty acids, present in fish oil in high amounts, has been documented. Furthermore, supplementing the diet with certain fatty acids has been shown to result in a reduced risk of cardiovascular events, have a positive impact on depression, a delay or even reverse of the destruction of joint cartilage and inflammatory pain associated with arthritic disease and a prophylactic effect against, or even treatment of, loss of bone density.

Due to these beneficial effects of PUFAs, fish oil has found extensive use in the preparation of feed and food products, as well as in the preparation of dietary supplements, novel food, functional food, nutraceuticals and pharmaceuticals, including liquid formulations, capsules and tablets.

The optimal supplement levels and/or ratio of the various vitamins and fatty acids in the diet depends on the target group, which may include babies (human milk replacers), children, adults, and specialty groups e.g. athletics, pregnant women, lactating women and individuals with predisposition/history of heart disease, arteriosclerosis, etc. Thus, there is a growing need for specialised, customised, dietary products that take into account the needs of different target groups.

One target group of particular concern is pregnant and lactating women that may need supply of essential PUFAs including DHA, EPA and ARA. During pregnancy, PUFAs are transferred from mother to fetus across the placenta. Specific fatty acid binding and transfer proteins mediate this placental transfer, which secures supply of essential PUFAs to the developing fetus. After birth, preterm and full-term babies are capable of converting linoleic and alpha-linolenic acids into ARA and DHA, respectively, but the activity of this endogenous PUFA synthesis is very low. However, breast milk provides preformed PUFAs, and breast-fed infants have higher PUFA levels in plasma and tissue phospholipids than infants fed conventional formulas. Accordingly, it is important to secure adequate levels of essential PUFAs in pregnant and lactating women, especially vegetarians, would benefit from increased levels of DHA and ARA in their diet.

Furthermore, some women may choose not to, or are unable to, breast-feed their infants for either a part of or all of the first year of the infant's life. The human breast milk is in those cases in general replaced by infant formulas. Supplementation of formulas with different sources of PUFAs can normalise PUFA status in the recipient infants relative to reference groups fed human milk.

However, human milk replacers have suffered from low levels of Arachidonic acid, as there has been limited possibilities of obtaining this fatty acid. Various methods have been proposed for producing increased levels of ARA in milk replacers, with variable results. EP 568 606 provides a PUFA-enriched additive which can be added to human milk replacers. The additive is obtained by the preparation of a blend of microbial oils containing DHA and ARA.

No method currently exists for obtaining such compositions in a natural way, i.e. directly from the biological species containing the compounds, without utilising means of chemical extraction and/or blending.

Thus, customised fatty acid products e.g. for pregnant women and infant formulas, are provided by blending oils of different origins e.g. from fish, vegetables, microbes etc., in order to obtain the desired ratio and amounts of the various nutritional components. The quality of such product is crucial and there is an ever-growing demand that fatty acids and other components used in such products be of a very high quality. This is usually taken to mean that they must be of a high purity, with minimal amounts of potentially toxic compounds and by-products, and that the components be obtained by methods that ideally do not involve chemical extraction and/or synthesis methods.

Oil or fatty acids can be extracted from fish without using chemical extraction and a high purity product can be obtained. However, production of other fatty acids of satisfactory purity generally involves chemical processing steps related to purification and/or extraction. During such processing steps there is a risk that impurities or undesired components are present in the final product or that chemical by-products such as oxidation products build up. Recently, there has been increased concern over the potential negative health effects of oxidized foods. These concerns are of particular importance in light of the problem of oxidized unsaturated fatty acid contamination in fatty acid products produced today.

Furthermore, long saturated fatty acids (eg. C20:0, C22:0, C24:0) may be present in oils produced from microbial sources. Such fatty acids are usually not present in the human diet and increased amounts of the saturated fatty acids generally have a lower digestibility than unsaturated fatty acids. Therefore, the content of these long saturated fatty acids should be minimized in nutritional and/or health products. It is further well known that during fermentation of microalgae, which may be used in production of certain fatty acids, like DHA and ARA, unwanted bacterial growth can be problematic.

As a consequence, it would be greatly advantageous if methods for obtaining oils containing nutritionally important fatty acids could be obtained without contamination by undesired compounds. Ideally, such methods would involve isolation of these fatty acids directly from their source in nature, with minimal intervention by chemical or other means.

The present invention provides a composition, and methods for preparing the composition, comprising fatty acids, including the PUFAs ARA, DHA and EPA, at levels, suitable for use in human nutrients, foods or food products, or in feed or feed products.

### SUMMARY OF THE INVENTION

Accordingly, in a first aspect the present invention provides a method of producing an oil, the method comprising the steps of a) feeding fish a composition comprising at least one non-endogenous fatty acid, or non-endogenous levels of at least one endogenous fatty acid, so as to obtain altered levels of an endogenous and/or non-endogenous fatty acid in said fish and b) extracting oil comprising altered levels of at least one fatty acid from said fish, or a body part thereof.

In a further aspect the present invention provides a method of purifying a composition comprising at least one fatty acid, the method comprising the steps of a) feeding a first composition to a fish and b) extracting a second composition comprising the at least one fatty acid from said fish, or a body part thereof.

In a still further aspect the invention relates to a method of preparing a triglyceride comprising feeding a composition comprising at least one fatty acid to a fish and extracting from said fish said triglyceride comprising said fatty acid.

In another aspect the present invention pertains to a method of rearing fish, said method comprising feeding fish a composition comprising at least one non-endogenous fatty acid, or non-endogenous levels of at least one endogenous fatty acid, and thereby altering levels of at least one fatty acid in said fish, or a body part thereof.

In yet another aspect, the present invention provides fish obtainable by any of the above described methods.

In a still further aspect, the present invention provides a fish comprising: Arachidonic acid of at least 1 wt % of total fatty acids, and/or Eicosapentaenoic acid of at least 10 wt % of total fatty acids, and/or Docosahexaenoic acid of at least 15 wt % of total fatty acids.

In yet a further aspect, the invention provides an oil obtainable from the method according to the first aspect of the invention.

In yet a further aspect, the present invention provides an oil from a fish comprising: at least 1 wt % of total fatty acids Arachidonic acid; and/or at least 10 wt % of total fatty acids Eicosapentaenoic acid; and/or at least 15 wt % of total fatty acids Docosahexaenoic acid.

In yet a further aspect, the present invention provides a method of using a marine animal as a biofactory for production of an oil, the method comprising the steps of a) administering to said marine animal a composition, wherein the fat portion of the composition comprises at least one non-endogenous fatty acid, or non-endogenous levels of at least one endogenous fatty acid and b) extracting oil from said at least one marine animal, or a body part thereof.

In a still further aspect, the present invention provides a composition comprising the oil as defined in the above aspects formulated as a nutraceutical, a dietary supplement, a functional food ingredient or as a food/feed additive.

In a final aspect, the present invention relates to the use of the oil according to the invention or the composition according to the invention for the preparation of a nutraceutical, a dietary supplement, a functional food product or as a food/feed additive.

### DETAILED DESCRIPTION

The present invention relates to a method of producing oil. The method comprises the steps of:

a) feeding fish a composition comprising at least one non-endogenous fatty acid, or non endogenous levels of at least one endogenous fatty acid, so as to obtain altered levels of an endogenous and/or non-endogenous fatty acid in said fish;

b) extracting oil comprising altered levels of at least one of said fatty acid from said fish, or a body part thereof.

This method thus allows the production of an oil with a composition, which may be designed, based on the particular needs of the user e.g. new born infants. Such “customised oil” is useful for many applications, some of which are described in greater detail in specific embodiments of the invention. According to the invention, it is possible to “alter the levels” of specific fatty acids, so as to obtain suitable levels of the desired fatty acids, which are either higher or lower than levels normally present in the fish, or a body part thereof.

The term “normally present” or “naturally present” is to be interpreted as the levels of fatty acids present in the fish, or a body part thereof, at the beginning of a feeding period i.e. when the fish has only been fed conventional feed. The feeding period may be started at any time during the juvenile or even the adult state of the fish.

The term “endogenous”, when used in the context of the present invention, refers to a fatty acid, or other molecular species, which is considered essential to the survival of the organism and/or naturally present in specified amounts in the fish, or a body part thereof. The amount of a particular molecular species present in the fish, or a body part thereof e.g. fatty acids and vitamins may be indicated in any suitable form e.g. for fatty acids as wt % of total fatty and for vitamins as parts per million (ppm).

All species not fulfilling the above criteria are considered to be “non-endogenous” in the present context. It should be noted that this definition is species-dependent in that certain molecular species may be endogenous to some fish or marine animal species, but not to others.

It follows from the above that the term “non-endogenous levels” refers to levels of a particular molecular species which are not normally present in the fish, or a body part hereof, or not normally present in conventional feed fed to the fish.

The present invention is exemplified with reference to a method of feeding fish a composition comprising fatty acids as defined above, and extracting oil comprising altered levels of at least one fatty acid. It is however to be understood, that the endogenous and non-endogenous molecular species may include, but are not limited to, any fat soluble species such as polyunsaturated and saturated fatty acids including, EPA (Eicosapentaenoic acid, C20:5n-3), DPA (Clypanodonic acid, C22:5n-3), DHA (Docosahexaenoic acid, C22:6n-3), ARA (Arachidonic acid, C20:4n-6), conjugated fatty acids including CLA (conjugated linoleic acid), caprylic acid (C8:0), capric acid (C10:0) and lauric acid (C12:0), thio fatty acids, phospholipids, cholesterol and other sterols, vitamin A, vitamin E, vitamin D and vitamin K.

A living animal used for the production of any specific chemical compound is defined as a biofactory. In the present context, a biofactory is a marine animal which can be used for the production of e.g. an oil with a customized fatty acid profile, as the oil provided by the present invention.

In the present context a marine animal may be any aquatic animal i.e. any animal living in an aquatic environment. Aquatic animals of particular relevance in relation to the present invention are all aquatic animals which can be farmed.

An “oil” is in the present context, considered to be any composition or extract comprising lipids; phospholipids, sterols and fatty acids or fatty acid esters. Such compositions are generally hydrophobic in nature, and are usually liquid at room temperature. However, certain oils are either very viscous, semi-solid or even solid at room temperature, but become liquid at elevated temperatures. An oil should however in the present context also be taken to encompass fish extracts, which may be aqueous in nature, but contain lipids and/or fatty acids of interest in the context of the present invention. Such fish oils may for example be obtained by grinding, pressing or otherwise extracting fish, or a body part thereof so as to obtain an oil according to the present invention. Suitable methods for extracting oil from fish are known to the skilled person. One useful extraction method is disclosed in patent application WO 00/23545, which is hereby incorporated by reference.

In accordance with the invention, the endogenous fatty acid profile may be altered in a marine animal, such as a fish. It is however contemplated that levels of any fat-soluble compound e.g. vitamins, cholesterol and phospholipids as mentioned above may be altered using the method of the present invention. It follows that an oil having an altered profile of vitamins etc is also encompassed by the present invention and that all aspects and embodiments of the inventions exemplified with reference to altering the fatty acid profile also applies for the molecular species mentioned above.

In one embodiment of the method of the present invention, the at least one fatty acid fed to the fish is a polyunsaturated fatty acid. It is furthermore possible that the at least one fatty acid fed to the fish is the same as, or different from, the fatty acid whose endogenous level is altered. In other words, by feeding fish one fatty acid, it is possible according to the invention to alter the levels of either the same fatty acid or another type of fatty acid.

The at least one fatty acid fed to the fish may be an omega-3 or an omega-6 polyunsaturated fatty acid, or a mixture thereof. The polyunsaturated fatty acid may in one embodiment be selected from the group consisting of Arachidonic acid, Eicosapentaenoic acid and Docosahexaenoic acid. However, other polyunsaturated fatty acids may also be fed to the fish, and are all within the application range of the present invention.

According to the invention, the composition fed to fish comprises components selected from the group consisting of free fatty acids, monoglycerides, diglycerides, triglycerides, fat fraction of a feed and/or food composition, fish oil, vegetable oil, microbial oil, microbial cells or cell parts, and fermentation broth. Other components suitable for use and serving the same purpose, i.e. to provide fish a supply of fatty acids or other molecular species of interest, are possible and will be apparent to those skilled in the art.

It is appreciated, that the composition fed to the fish comprises all nutrients which are necessary to sustain life of the animal. Commercial fish feed may be enriched by adding some of the above mentioned components or a fish feed may be designed especially for obtaining the fatty acid profile of interest.

In one specific embodiment of the invention, the level of at least one fatty acid in the fish, or a body part thereof, or in the extracted oil, is altered in:

Arachidonic acid content to a level of at least 1 wt % of total fatty acids, such as a level of at least 1.5 wt %, 2 wt %, 3 wt %, 5 wt %, 7 wt %, 10 wt %, 15 wt %, 20 wt % or even 30 wt % of total fatty acids and/or Eicosapentaenoic acid content to a level of at least 10 wt % of total fatty acids, such as a level of at least 12 wt %, 15 wt %, 20 wt % or even 30 wt % of total fatty acids, and/or Docosahexaenoic acid content to a level of at least 15 wt % of total fatty acids such as a level of at least 20 wt %, 25 wt %, 30 wt % or even 40 wt % of total fatty acids.

The terminology “and/or” should be taken to mean that any combination of the listed species can be selected and achieved. Thus, any combination of Arachidonic acid, Eicosapentaenoic acid and/or Docosahexaenoic acid in the ranges stated are possible according to the broadest aspect of the present invention. This should be taken to mean that any one, two or three of these fatty acids can simultaneously be obtained within the stated levels according to the invention.

In suitable embodiments of the present invention the ratio between the ARA and DHA (ARA/DHA) in the extracted oil is at least 0.2, such as 0.3-3.0, e.g. 1-2 e.g. 0.5-0.75, including a ratio of 0.4, 0.5 and 0.6. In this specific embodiments of the present invention, is it preferred that the level of EPA is as low as possible i.e. the content of EPA is below 10 wt % of total fatty acids, such as below 7 wt %, 6 wt %, 5 wt %, 4 wt %, 3 wt %, 2 wt % or even below 1 wt % of total fatty acids.

In one embodiment of the invention extracted liver oil with a high content of total omega-3 fatty acids including EPA and DHA is possible. Feeding regimes of e.g. cod makes it possible to achieve higher content of total omega-3 than what is presently found in commercial cod liver oil. Thus extracted oil with a DHA content of at least 10 wt % of total fatty acids, such as 12 wt %, 14 wt %, 16 wt %, 18 wt %, 20 wt %, 22 wt %, 24 wt %, 26 wt %, 28 wt % or even 30 wt % of total fatty acids or higher and/or an EPA content of at least 12 wt % of total fatty acids, 14 wt %, 16 wt %, 18 wt % or even 20 wt % of total fatty acids or higher, and/or a total omega-3 fatty acid content of at least 30%, 32%, 34%, 36%, 38% or even 40% or higher, may be produced.

In the present context the expression “omega-3 fatty acids” are defined as the following acids: alpha-linolenic acid (C18:3 n-3), morotic acid (C18:4 n-3), eicosatetraenoic acid (C20:4 n-3), timnodonic (eicosapentaenoic; EPA) acid (C20:5 n-3), heneicosapentaenoic acid (21:5 n-3), clupanodonic acid (C22:5 n-3) and cervonic (docosahexaenoic) acid (C22:6n-3; DHA). The definition corresponds to the definition used by the European Pharmacopoeia 01/2003:1912.

In another interesting embodiment extracted liver oil with an elevated level of ARA and a designed ratio between ARA and DHA is possible. Feeding regimes of e.g. cod makes it possible to achieve levels of ARA of 2 wt % of total fatty acids, such as 4 wt %, 6 wt %, 8 wt %, 10 wt % or higher and at the same time ratios between ARA and DHA that are not found in commercial cod liver oil including a ratio of 1:5, 1:3, 1:1 or 2:1 or even 3:1, and at the same time a reduced level of EPA to a content of about 10 wt % of total fatty acids, such as about 8 wt %, 6 wt %, 4 wt % or even about 2 wt % or a lower of total fatty acids.

In order to obtain the altered levels and/or combination of levels of the specific fatty acids as mentioned above the fish is fed a composition, wherein the fat portion of said feed composition comprises:

at least 2 wt % of total fatty acids Arachidonic acid, such as at least 5 wt %, 10 wt %, 15 wt %, 20 wt % or even 30 wt % of total fatty acids Arachidonic acid, and/or at least 7 wt % of total fatty acids Eicosapentaenoic acid, such as at least 10 wt %, 15 wt %, 20 wt % or even 30 wt % of total fatty acids Eicosapentaenoic acid, and/or at least 9 wt % of total fatty acids Docosahexaenoic acid such as at least 15 wt %, 20 wt % or even 30 wt % of total fatty acids Docosahexaenoic acid.

This should be taken to mean that any combination of Arachidonic acid, Eicosapentaenoic acid and/or Docosahexaenoic acid in the stated ranges is possible in the feed composition. Thus, any one, two or three of these fatty acids can simultaneously be specified in the stated levels in the feed compositions fed to the fish in accordance with the method of the invention.

As stated, in a specific embodiment of the invention it may be preferred to lower levels of Eicosapentaenoic acid content in the oil to a level below 10 wt % of total fatty acids, such as below 7 wt %, 5 wt %, 3 wt %, or even below 2 wt % of total fatty acids. In order to obtain such low levels the composition feed to the fish may comprise low levels of Eicosapentaenoic acid. Such low levels include levels of Eicosapentaenoic acid below 7 wt %, 5 wt %, 3 wt %, or even below 1 wt % of total fatty acids in the feed composition.

The feed composition used in the present invention can be any feed suitable for feeding a particular fish or a marine animal species. For example, the feed can be in solid form, an aqueous solution or dispersion of a solid feed product, or the feed product can be comprised of living organisms, such as single-cell organisms or other organisms suitable for use as a feed.

In a further embodiment, the present invention relates to a method of producing an oil which in addition to the steps as described above further comprises the steps of

c) determining the level of at least one fatty acid in the oil in step b);

d) adjusting the fatty acid content of the feed composition in step a) in response to said level of at least one fatty acid;

e) feeding remaining fish said adjusted feed composition;

f) repeating steps c-f until the altered fatty acid profile in the oil has been obtained.

Methods for determining levels of fatty acids as well as other molecular species of relevance according to the present invention are well known in the art. The person of skill will be able to select a suitable method for measuring and determine the level and/or amount of a specific molecular species e.g. fatty acid present in the oil.

The invention therefore provides a method for obtaining oil with a fatty acid composition that can be manipulated so as to achieve desired levels of specific fatty acid(s). This can be done by adjusting the fatty acid composition of the feed given to the fish in response to the level of the fatty acids in the oil that is obtained from the fish as described above. This can readily be done during the farming of fish, which typically takes a period of time which ranges from weeks to months or even years. The present invention therefore provides a method of producing an oil with a customised fatty acid profile, i.e. an oil with a composition of specific fatty acids, which can be determined in a user-dependent manner.

Thus, an interesting feature of the present invention is the possibility of enriching fish oil in fatty acids, or levels of fatty acids, which has not previously been described. One such fatty acid is Arachidonic acid. In the art, levels of Arachidonic acid in fish oil e.g. cod liver oil, are described as being present in amounts below 1.0 wt % of total fatty acid. The method according to the present invention provides fish oil having levels of Arachidonic acid as defined above. Thus, according to the invention, it is possible to obtain levels of Arachidonic acid in fish oil which is very high, and suitable e.g. in the manufacture of nutritional supplements, such as infant formula.

In a presently preferred embodiment, fish of the Gadidae species such as cod (Gadus morhua), is used to obtain oil with high levels of ARA. Other interesting species for obtaining oil with high levels of ARA includes but are not limited to saithe (Pollachius virens), hake (Merluccius merluccius), Southern hake (Merluccius australis).

In accordance with the invention, the oil obtained by the methods of the invention has an omega-3 fatty acid content of at least 26 wt % of total fatty acids, more preferably at least 28 wt % of total fatty acids, such as at least 30 wt % of total fatty acids, 32 wt %, 34 wt %, 36 wt % or even at least 40 wt % of total fatty acids. Such oil is expected to be useful in various food and/or feed supplements, since omega-3 fatty acids are known to be beneficial to human and animal health.

In yet a further embodiment of the present invention, the percentage of at least one fatty acid in the oil is altered to a level higher than the level of said at least one fatty acid in oil obtainable from the fish prior to feeding. Such elevated levels are typically obtained by feeding the fish a feed composition comprising an increased level of the specific fatty acid as compared to the level of the fatty acid of interest present in the fish prior to feeding. It should however be understood that the mechanism of increasing levels of particular fatty acids not always follows the above pattern. Thus, it may be possible, according to the invention to obtain higher levels of fatty acids in oil obtainable from fish than present in the feed given to the fish. The levels in the feed may even be lower than the levels in the fish prior to feeding the fish. Therefore, it is possible to enrich the fatty acid content of specific fatty acids, by using the fish as a “biofilter”, to selectively increase the fatty acid content of the natural fish oil in specific fatty acids. The fatty acid may in one embodiment be DHA, in another embodiment the fatty acid is ARA.

As can be seen from the examples provided herein, the fatty acid composition of oils feed to a fish can be clearly differentiated from the oil extracted from said fish after feeding for a certain period of time, irrespective of specific levels of particular fatty acids. While not intending to be limited by theory, it is believed that the enrichment characteristics or modification of the oil involve the recycling of fatty acids during metabolic processing in the fish. Thus, in cod for example, fatty acids are removed from triglycerides in the gut, catalysed by endogenous phospholipases. The free fatty acids are used for tissue growth and other physiological processes in the fish, and storage of excess fatty acids takes place in the fish liver, where fatty acids are stored in the form of triglycerides. During this physiological recycling process, the fatty acids are thus removed from triglycerides, and later added back during the storage process in the liver. The location of fatty acids on the triglycerides may also be altered during the process. This means that a particular fatty acid may be predominantly in one position in the triglyceride comprised in the composition fed to the fish, but may end up in a primarily different position in the triglyceride subsequently extracted from the fish. This in vivo processing opens up the possibility for enrichment of specific fatty acids. For example, if a particular fatty acid is not needed or not desired in high quantities in the fish tissue, excess fatty acid is stored in the liver. This can therefore lead to gradual build up of the fatty acid in the liver. Even if the feed or food product has a fatty acid content which is lower than the initial fatty acid content of the fish, it is possible that the levels in the fish liver increase with time. The degree of endogenous synthesis of the fatty acids, the specific need for the fatty acid in the fish, and the level of the fatty acid in the food or feed, will determine if, and then to what extent, the fatty acid will be enriched in the fish.

The length of the time period during which the fish is fed will regulate the composition of the oil extractable from the fish. Thus, the fish may be fed over a period of at least 6 weeks, preferably at least 12 weeks, more preferably at least 18 weeks, most preferably at least 22 weeks. Longer periods, such as at least 25 weeks, at least 35 weeks or longer such as up to 1 year, up to 1½ years, or even up to 5 years. The suitable time period will in general depend on various factors, including the fish species, the age of the fish at the start of feeding, the feed composition used to feed the fish, the desired fatty acid composition of the oil extractable from the fish, as well as other generic factors including temperature, growth rate of the fish, etc.

The feed composition used can, as mentioned earlier, be of a wide range of compositions. It may be advantageous to have a high content of fat in the feed composition in order to supply the amount of fatty acids needed. High levels of fat in the feed may be detrimental to certain fish species. However, other species may tolerate high levels of fat, and as a result a wide range of compositions are possible. According to the present invention, the feed composition may comprise at least 5 wt % fat (percentage total fat in the feed composition), such as at least 10 wt % fat, such as at least 15 wt % fat, such as at least 20 wt % fat, such as at least 25 wt % fat, or even at least 30 wt % fat.

In a further aspect, the present invention also relates to oil obtainable from the methods of the present invention and a fish oil with the characteristic profile and/or content of fatty acids as described in accordance with the aspect of the present invention relating to method of producing an oil.

As stated, any fish species may be used for producing an oil according to the present invention. Many fish species store fatty acids in their tissues and it is foreseeable that the methods of the present invention will be applicable for a wide range of fish species, depending on the particular use and/or desired properties of the particular oil product.

Fish species that store fatty acids in their liver are of particular usefulness in the context of the present invention. The liver is an adaptable organ, and can build up and store large quantities of fatty acids, which may be quite desirable for specific use of the methods of the present invention.

In a preferred embodiment, therefore, the fish species is from the Gadidae family, to which cod (Gadus morhua), saithe (Pollachius virens), hake (Merluccius merluccius) and Southern hake (Merluccius australis) belongs. Such species are of particular use, as they use the liver as storage organ for fatty acids in the form of triglycerides. Other species with means for storing fatty acids in the liver are expected to be equally applicable in the context of the present invention. Further, the method can be generalised to include any specific fish species, as well as different fish body parts. Thus, while in one embodiment the fish body part used for producing oil is fish liver, it should be appreciated that other fish body parts can be used to obtain fish oil by applying the methods of the invention.

A further consequence of the in vivo processing of fat in fish such as cod, is that undesirable fatty acids, as well as fatty acid oxidation products, may be filtered out by the fish. Thus, unwanted fatty acids and fatty acid oxidation products will be removed in the gut and expelled by the fish, or metabolised and not stored as triglyserides. This in vivo biofiltering effect therefore results in an oil extractable from the fish, which has low or undetectable amounts of undesirable fatty acids or other contaminating components.

This biofiltering effect can be expected to be especially useful for embodiments of the invention, in which high quality natural fish oil is desired. One such example is natural fish oil to be used as supplement for infant milk replacement formula. Furthermore, the biofiltering effect has the effect that it may be possible to use a relatively low grade feed product to feed the fish, since the internal biofilter will selectively remove undesired components of the feed. This can be an important cost-saver in the production of certain oil products. One example is the production of an Arachidonic acid containing fish oil. Presently, Arachidonic acid must be extracted and purified from a source such as e.g. a microbial fermentation. In order to secure the quality of the final product the broth undergoes several cost consuming and expensive purification steps. Using the method of the present invention makes it possible to feed the fermentation broth or a dewatered fermentation broth, to the fish and then extract pure oil directly from the fish using cheaper methods.

In a further aspect therefore, the present invention provides a method of purifying a composition comprising at least one fatty acid as described hereinbefore, the method comprising the steps of:

a) feeding a first composition to a fish;

b) extracting a second composition comprising the at least one fatty acid from said fish, or a body part thereof.

The first composition may comprise a non-endogenous fatty acid, or non-endogenous levels of an endogenous fatty acid as defined herein. In one embodiment, the composition fed to the fish comprises a polyunsaturated fatty acid. In another embodiment, the composition comprises an omega-3 or an omega-6 polyunsaturated fatty acid, or a mixture thereof. In useful embodiments, the composition comprises fatty acids selected from the group consisting of Arachidonic acid, Eicosapentaenoic acid and Docosahexaenoic acid as previously described. In yet another embodiment, the polyunsaturated fatty acid is ARA.

The extracted composition may be characterised in content and levels of fatty acids as described hereinbefore. Further, the extracted composition may have an omega-3 fatty acid content of at least 26 wt % of total fatty acids, more preferably at least 28 wt % of total fatty acids, such as at least 30 wt % of total fatty acids, 32 wt %, 34 wt %, 36 wt % or even at least 40 wt % of total fatty acids.

In a further aspect, the present invention provides a method of preparing a triglyceride, the mechanism is as described hereinbefore. It has been found that it is possible to take advance of the natural ability of the fish to metabolise ingested triglycerides or use provided free fatty acids from feed for building up “new triglycerides”.

The method of preparing a triglyceride comprises feeding a composition comprising at least one fatty acid, optionally in the form of a triglyceride, to a fish and extracting from said fish said triglyceride comprising said fatty acid. The at least one fatty acid fed to the fish may be a non-endogenous fatty acid, or non-endogenous levels of an endogenous fatty acid. The at least one fatty acid fed to the fish may further be a polyunsaturated fatty acid, such as an omega-3 or an omega-6 polyunsaturated fatty acid, or a mixture thereof. In one embodiment, the polyunsaturated fatty acid is selected from the group consisting of Arachidonic acid, Eicosapentaenoic acid and Docosahexaenoic acid.

The present invention provides in another aspect a fish feed comprising at least 2 wt % of total fatty acids Arachidonic acid, and/or at least 7 wt % of total fatty acids Eicosapentaenoic acid, and/or at least 9 wt % of total fatty acids Docosahexaenoic acid. Other useful levels can be as previously described.

In yet another aspect, the present invention provides a method of rearing fish, said method comprising feeding fish a composition comprising at least one non-endogenous fatty acid, or non-endogenous levels of an endogenous fatty acid, and thereby altering levels of at least one fatty acid in said fish, or a body part thereof. The at least one fatty acid fed to the fish may be a polyunsaturated fatty acid, such as an omega-3 or an omega-6 polyunsaturated fatty acid, or a mixture thereof. In one embodiment, the polyunsaturated fatty acid is selected from the group consisting of Arachidonic acid, Eicosapentaenoic acid and Docosahexaenoic acid.

According to this aspect of the invention, the level of at least one fatty acid is altered as described above by feeding the fish a composition, which has also been defined above.

The level and ratio of fatty acids may be altered in Arachidonic acid, Eicosapentaenoic acid and Docosahexaenoic acid as described above. Furthermore, the endogenous omega-3 fatty acid content may be at least 30 wt % of total fatty acids, more preferably at least 32 wt % of total fatty acids, even more preferably at least 34 wt % of total fatty acids, most preferably at least 36 wt % or even 40 wt % of total fatty acids.

The fish may be fed over a period of at least 6 weeks, preferably at least 12 weeks, more preferably at least 18 weeks, most preferably at least 22 weeks or even longer as previous stated. The fish may further be fed a composition comprising at least 5 wt % fat, such as at least 10 wt % fat, such as at least 15 wt % fat, such as at least 20 wt % fat, such as at least 25 wt % fat, such as at least 30 wt % fat.

The composition fed to fish may contain components as described before and/or other components suitable for use and serving the same purpose. The choice of relevant component will be apparent to those skilled in the art as mentioned before.

In another aspect, the present invention relates to fish obtainable by the method of rearing fish as encompassed by the present invention. The fish may be of any species; in one embodiment, the fish is of a Gadidae species. Other species useful in the context of the present aspect of the invention are, as described before, equally applicable.

In yet a further aspect, the invention relates to fish comprising Arachidonic acid of at least 1 wt % of total fatty acids, and/or Eicosapentaenoic acid of at least 10 wt % of total fatty acids, and/or Docosahexaenoic acid of at least 15 wt % of total fatty acids.

In a further aspect, the present invention relates to an oil from a fish comprising: Arachidonic acid content to a level of at least 1 wt % of total fatty acids, such as a level of at least 3 wt %, 5 wt %, 7 wt %, 10 wt %, 15 wt %, 20 wt % or even 30 wt % of total fatty acids and/or Eicosapentaenoic acid content to a level of at least 10 wt % of total fatty acids, such as a level of at least 12 wt %, 15 wt %, 20 wt % or even 30 wt % of total fatty acids, and/or Docosahexaenoic acid content to a level of at least 15 wt % of total fatty acids such as a level of at least 20 wt %, 25 wt %, 30 wt % or even 40 wt % of total fatty acids.

In a presently preferred embodiment the oil may comprise at least 1 wt % of total fatty acids Arachidonic acid; and/or at least 10 wt % of total fatty acids Eicosapentaenoic acid; and/or at least 15 wt % of total fatty acids Docosahexaenoic acid. The interpretation of the term “and/or” when used in the present context has been described hereinbefore.

The oil may be obtainable from any fish, such as from a Gadidae species. Further, the oil may be obtainable from any fish body part, such as from a fish liver.

It is appreciated that levels and ratio of particular fatty acids and the total amounts of omega-3 fatty acid content in the fish, or a body part thereof, in the oil or in the feed can be within the ranges and specific levels as previously described. It should further be evident that this applies to all aspects and embodiments of the invention

The oil as obtained in accordance with the present invention may further comprise fatty acids and/or triglycerides of animal-, vegetable and/or microbial origin. It is thus possible to use the oils of the present invention in any combination, blend or mixture with oils of other origins so as to obtain an oil blend with a specific, desired composition and content of fatty acids and/or any other molecular species of interest.

In a further aspect, the present invention provides a method of using a marine animal as a biofactory for production of an oil. The method comprises the steps of

a) administering to said marine animal a composition, wherein the fat portion of said composition comprises at least one non-endogenous fatty acid, or non-endogenous levels of an endogenous fatty acid;

b) extracting oil from said at least one marine animal, or a body part thereof,

The marine animal may in one embodiment be a fish, such as fish of a Gadidae species. Further, the at least one fatty acid may be a polyunsaturated fatty acid or any other molecular species as described hereinbefore.

As previously described, during the physiological recycling process of fatty acids in certain types of fish, such as cod, fatty acids are removed from triglycerides in the gut and later added back during the storage process in the liver. This means that the chemical composition of individual triglyceride molecules obtainable from the fish are different from their composition in the food or feed product, as originally taken up by the fish (cf. example 2). This endogenous recycling process further provides possibilities of enrichment of specific fatty acids in marine animals, including certain fish species. Thus, by the methods of the invention, it is possible to use marine animals as a biofactory for the production of oil.

The oil of the present invention can be used in a variety of compositions. Thus, in one aspect, the invention relates to a composition formulated as a pharmaceutical, a nutraceutical, a dietary supplement or as a food/feed additive. A specific composition, comprising oils of the present invention, relates to a composition formulated as an infant formula. Preferably, such compositions are designed to have a fatty acid profile which is comparable to the fatty acid profile found in human breast milk.

The oils of the present invention may further be used in a method for the preparation of a medicament, a nutraceutical, a dietary supplement or as a food/feed additive. The medicament, nutraceutical, food additive or dietary supplement may be used for supporting the growth development of a human infant.

A further aspect of the present invention is that the oil extractable from fish or other marine animals can also be a source of natural vitamins. Thus, fat-soluble vitamins as vitamin A, vitamin D, vitamin E, vitamin K and provitamins, which are provided in the food/feed, and possible also synthesised in vivo in the fish or the marine animal, are stored in the animal, and will be a component of the extracted oil. Therefore, the present invention also pertains to an oil that not only has a desired and specific fatty acid composition, but may also comprise natural vitamins in specific and desired amounts.

It should be understood that specific features and embodiments of the present invention as previously described can be combined with, and linked to, all aspects of the invention.

The invention is further illustrated in the following non-limiting examples and in the figures, where:

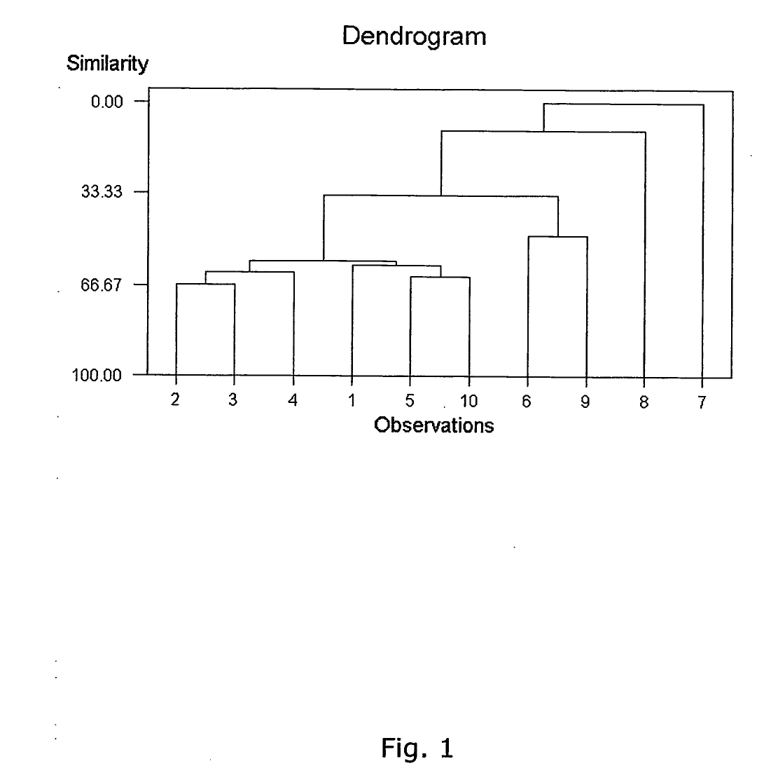

FIG. 1 illustrates the clustering of the samples 1-10 using hierarchical cluster analysis. The samples 1-5 and 10 (extracted fish oils) are all clustered together whereas the samples 6-9 (commercial oils used in the fish feed) fall in separate clusters.

### EXAMPLES

### Example 1

Introduction

A feeding trial with cod (Gadus morhua) was performed to specifically alter the fatty acid composition of the liver lipids. Cod with an average weight of 2.2 kg were fed four experimental diets for 5 months. The relative amount of DHA (docosahexaenoic acid 22:6n-3), EPA (eicosapentaenoic acid, 20:5n-3) and ARA (arachidonic acid, 20:4n-6) in the feed varied from 8.7-23.8% (DHA), 5.6-15.5% (EPA) and 0.9-11.9% (ARA). After 5 months of feeding the amount of ARA in cod liver lipids increased from 0.4 to 4.5%, DHA increased from 14.2 to 20.6% when high levels of DHA were fed. The alteration in the amount of EPA was less than for both ARA and DHA, and a higher degree of conservation of DHA than EPA was observed.

Materials and Methods

Cod (Gadus morhua) with an average weight of 2.2 kg, was kept in 2×2×1 m indoor tanks at constant sea water temperature of 8° C., and fed four experimental diets. The diets consisted of fish meal, wheat and standard premixes of vitamins and minerals. One batch of extruded pellets were used, and coated with different oil mixes. Thus, the added lipid fraction was the only feed ingredient differing between the experimental diets. The chemical composition of the diets are shown in Table 1.

Extruded pellets were coated with different blends of oils. Fatty acid composition of the final diets is shown in table 2. The relative amount of DHA in the feed varied between 8.7-23.8%, EPA varied between 5.6-15.5% and ARA between 0.9-11.9%. Total amount of omega-3 fatty acids in the feeds varied between 26 and 35%.

7 fish from each of the dietary groups were sacrificed after 6, 12 and 22 weeks of feeding. Weight and length was recorded, and livers and muscle samples were dissected. Livers were kept at +4° C. and processed no later than 24 hours after collection. Muscle samples were kept at −20° C. until analysis. To obtain cod liver oil the livers were gently heated on a direct cooking plate, and centrifuged to separate the oil phase from the protein phase. The amount of fat in cod muscle was determined with ethyl ether extraction.

Results

The fatty acid composition of the cod liver oil obtain from the fish at different collection times are shown in Table 3. After 12 weeks on experimental diets clear differences between dietary groups was observed, and for ARA and DHA the differences became more pronounced after 22 weeks of feeding.

Increasing the amount of ARA in the feed from 0.9 to around 11% led to an increase in liver ARA from 0.4 to 4.5% after 5 months. Elevated levels of DHA in the feed was reflected in higher levels of DHA in the liver, and more than 20% liver DHA was found in the group fed the highest levels of DHA.

The amount of EPA in the feed was less altered than ARA and DHA, and smaller changes in liver EPA were observed between groups.

The muscle tissue of the cod had less than 1% fat in all dietary groups after 5 months of feeding.

The cod grew from 2.2 to 2.7 kg during the trial. No difference in growth between groups was observed. The hepatosomic index (liver weight/fish weight*100) was 12.7 at the start of the experiment, and varied between 11.8 and 13.3 in the experimental groups after 5 months of feeding (results not shown). No mortality was observed during the study.

Discussion

The results clearly show that it is possible to alter the fatty acid composition of cod liver oil through changes in the fatty acid composition of the feed. Lie et al. (1986) showed that dietary fat had a strong influence on the composition of liver triglycerides (liver lipids). However, the results of the present experiment have shown that it is possible to achieve higher levels of ARA (>4%) and DHA (>20%) in farmed cod liver oil than earlier reported, and in much higher levels than in commercially available cod liver oil from wild cod 8% EPA, 12% DHA, <1% ARA and 25% total omega-3 fatty acids (Denofa, product specifications December 2002) (ARA<1%, DHA<18%, Table 4, in Lambertsen and Braekkan, 1985).

When levels of ARA in the feed for juvenile turbot and halibut are increased to about 2.5%, problems with pigmentation occurs (McEvoy et al., 1998), indicating that ARA have a negative effect in high doses in juvenile fish. A ratio EPA:ARA of at least 4:1 was found to give the best results when fed to halibut and turbot larvae. No information on the effect of high feed levels of ARA on juvenile cod has been found. In the present experiment ARA accounted for more than 10% of feed lipids in two of the diets and no adverse effects were observed in growth, hepatosomatic index or mortality.

The total amount of omega-3 fatty acids in liver lipids from fish fed experimental diets increased with 20% to more than 35% of total fatty acids after 5 months. A pilot study, prior to the current experiment, showed that, with a feed similar to diet 4, it is possible to increase the total amount of omega-3 in the liver lipids of codfish to more than 40%, when a longer feeding period is used.

Prior to the start of the present experiment, the cod was fed commercial cod feed from Dana Feed (Horsens, Denmark) with 15% fat and 62% protein. Increasing the fat level to around 30% did not lead to an elevated hepatosomic index, nor a higher level of fat in the muscle.

TABLE 1
Chemical composition of diets

| | Diet 1 | Diet 2 | Diet 3 | Diet 4 |
|---|---|---|---|---|
| Fat (%) | 28.4 | 31.6 | 27.4 | 30 |
| Protein (%) | 41.7 | 40.9 | 42.3 | 41.2 |
| Water (%) | 4.9 | 4.7 | 4.7 | 4.4 |
| Ash (%) | 8.4 | 7.8 | 8.4 | 8.4 |

TABLE 2
Fatty acid composition of diets

| Fatty acid | Diet 1 | Diet 2 | Diet 3 | Diet 4 |
|---|---|---|---|---|
| C 12:0: | | | | |
| C 13:0 | | | | |
| C 14:0 | 4.2 | 2.1 | 2.7 | 5.3 |
| C 14:1 n5 | 0.2 | | | 0.2 |
| C 15:0 | 0.4 | 0.6 | 0.7 | 0.5 |
| C 16:0 | 17.3 | 15.7 | 17.6 | 18.1 |
| C 16:1 n7 | 4.9 | 3.6 | 4.7 | 6.3 |
| C 16:2 n6 | 0.6 | 0.2 | 0.3 | 0.9 |
| C 17:0 | 0.4 | 0.7 | 0.8 | 0.5 |
| C 17:1 | 0.7 | | | 1.0 |
| C 16:3 n3 | | 0.4 | 0.5 | |
| C 16:4 n3 | 1.0 | | 0.2 | 1.4 |
| C 18:0 | 5.4 | 6.0 | 5.2 | 4.0 |
| C 18:1 n9 | 10.8 | 12.3 | 13.4 | 11.1 |
| C 18:1 n7 | 2.4 | 2.1 | 2.6 | 3.0 |
| C 18:2 n6 | 3.6 | 3.7 | 2.6 | 2.4 |
| C 19:0 | 0.9 | 0.9 | 0.2 | 0.3 |
| C 18:3 n6 | | | | |
| C 18:3 n3 | 0.6 | 0.5 | 0.6 | 0.8 |
| C 18:4 n3 | 1.6 | 0.8 | 1.0 | 2.2 |
| C 18:4 n1 | | | | 0.2 |
| C 20:0 | 0.5 | 0.5 | 0.4 | 0.3 |
| C 20:1 n11 | 0.4 | 0.6 | 0.6 | 0.5 |
| C 20:1 n9 | 2.6 | 2.6 | 2.9 | 2.8 |
| C 20:1 n7 | 0.3 | | | 0.4 |
| C 20:2 | 0.3 | 0.4 | 0.3 | 0.2 |
| C 20:3 n6 | 1.0 | 1.0 | | |
| C 20:4 n6 | 11.3 | 11.9 | 1.8 | 0.9 |
| C 20:3 n3 | | | | |
| C 20:4 n3 | 0.5 | 0.4 | 0.5 | 0.7 |
| C 20:5 n3 | 11.4 | 5.6 | 6.8 | 15.5 |
| C 22:0 | 0.6 | 0.6 | 0.3 | |
| C 22:1 n11 | 2.8 | 2.4 | 2.7 | 0.5 |
| C 22:1 n9 | 0.4 | 0.4 | 0.4 | 0.5 |
| C 21:5 n3 | 0.5 | 0.2 | 0.3 | 0.7 |
| C 23:0 | | 0.2 | 0.2 | |
| C 22:4 n6 | 0.2 | 1.3 | 1.7 | 0.3 |
| C 22:5 n3 | 1.5 | 1.1 | 1.4 | 2.1 |
| C 24:0 | 0.5 | 0.6 | 0.3 | |
| C 22:6 n3 | 8.7 | 18.4 | 23.8 | 11.7 |
| C 24:1 | 0.6 | 0.6 | 0.7 | 0.7 |

TABLE 3
Fatty acid composition (selected fatty acids) of feed and
cod liver oils from fish fed different experimental diets.
Analysis of pooled samples of livers from 7 fish.

| | | Feed | Start | 6 weeks | 12 weeks | 22 weeks |
|---|---|---|---|---|---|---|
| Group 1 | ARA | 11.3 | 0.4 | 0.7 | 1.8 | 4.3 |
| | EPA | 11.4 | 10.3 | 10.4 | 10.5 | 12.3 |
| | DHA | 8.7 | 14.2 | 14.1 | 14.2 | 14.6 |
| | Total w3 | 26 | 30.4 | 29.3 | 30.9 | 32.8 |
| Group 2 | ARA | 11.9 | 0.4 | 1.1 | 2.4 | 4.5 |
| | EPA | 5.6 | 10.3 | 9.8 | 9.8 | 9.5 |
| | DHA | 18.4 | 14.2 | 14.6 | 16.5 | 19.1 |
| | Total w3 | 27.5 | 30.4 | 30.4 | 32.4 | 33.6 |
| Group 3 | ARA | 1.8 | 0.4 | 0.5 | 0.6 | 0.7 |
| | EPA | 6.8 | 10.3 | 10.1 | 9.7 | 10 |
| | DHA | 23.8 | 14.2 | 15.2 | 17.1 | 20.6 |
| | Total w3 | 35.1 | 30.4 | 31.1 | 32.8 | 35.9 |
| Group 4 | ARA | 0.9 | 0.4 | 0.4 | 0.5 | 0.5 |
| | EPA | 15.5 | 10.3 | 10.9 | 11.2 | 13.2 |
| | DHA | 11.7 | 14.2 | 13.9 | 14.2 | 15.5 |
| | Total w3 | 35 | 30.4 | 31 | 31.8 | 35 |

### Example 2

The objective of this study was to test whether sufficient information could be obtained so as to chemically differentiate among oil blends comprising microbial ARA (20:4n-6), tuna oil DHA (22:6n-3), South American fish oil (C20:5n-3 and 22:6n-3) and liver oils from cod fed with these blends.

Materials and Methods

Samples

In Example 1 Tuna fish oil (high in DHA), South American fish oil (high in EPA and DHA) and microbial ARA oil (high in ARA) were used in the cod feed. These oils, a blend between tuna oil and microbial ARA oil and liver oils from cod before and after feeding experimental diets were prepared for ¹³C NMR analysis. The different samples are described in Table 4 below. Sample 2 and sample 10 were taken from the same feeding groups after different feeding time with experimental diet.

TABLE 4
Samples used for ¹³C-NMR analysis

| Sample No | Description |
|---|---|
| 1 | Liver oil from cod after 22 weeks feeding with an |
| | experimental feed. Feed coated with a blend of South |
| | American fish oil and microbial ARA oil |
| | (diet 1 of Example 1). |
| 2 | Liver oil from cod after 22 weeks feeding with an |
| | experimental feed. Feed coated with a blend of |
| | tuna oil and microbial ARA oil (diet 2 of Example 1). |
| 3 | Liver oil from cod after 22 weeks feeding with an |
| | experimental feed. Feed coated with tuna oil |
| | (diet 3 of Example 1). |
| 4 | Liver oil from cod after 22 weeks feeding with an |
| | experimental feed. Feed coated with South American |
| | fish oil (diet 4 of Example 1). |
| 5 | liver oil from cod at day 0 (before feeding with |
| | experimental diets) |
| 6 | Tuna fish oil |
| 7 | Microbial ARA oil |
| 8 | South American fish oil |
| 9 | Blend of tuna oil and microbial ARA oil (used to |
| | coat the feed fed to the cod from where sample 2 |
| | was taken) |
| 10 | Liver oil from cod after 16 weeks feeding with |
| | experimental feed. Feed coated with a blend of |
| | tuna oil and microbial ARA oil (diet 2 of Example 1). |

¹³C-NMR Analysis

Samples of oils were mixed with chloroform before NMR analysis. ¹³C-NMR-analyses were carried out on a Bruker DRX-500 with the following experimental parameters: frequency: 125.770317 MHz, sweep width: 25252.5 Hz, dwell time: 39.6 us, acquisition time: 2.595 sec, offset frequency: 12515.2 Hz, number of points: 65536, recycle delay 0.0 sec, number of acquisitions: 2048.

For post-processing a line broadening of 0.1 Hz was applied (to minimize overlap among closely spaced resonances and to preserve chemical shift information for the subsequent data analyses). Furthermore, detailed examination of the data revealed small variations in resonance positions of comparable peaks in different samples. Variations in the positions may arise from differences in relative concentrations, ionic strength, pH, temperature effects/gradients, inter- and intra-molecular variations, magnetic field homogeneity variations, and shimming effects. Corrections were applied to all samples to optimize consistency among the peak positions [and subsequent calculations]. Although more automated, but nonetheless time consuming, methods/algorithms are available for automated peak alignment procedures, in the present case each spectrum was inspected visually and resonances assigned/modified by hand to ensure accuracy and consistency of the data.

Preparation of Data for Statistical Tests

To reduce the complexity of the calculations, all noise was removed by peak picking all resonances with an intensity within each spectrum of greater than 1.2% of the peak maximum in that spectrum. These peak lists were then combined to produce a final overall list of relevant chemical shifts. These peak lists were then combined to derive the data matrix subsequently used for multivariate analysis. Some spectra may contain additional resonances less than this 1.2% peak maximum threshold in addition to selected peaks greater than this value that may have shown up in only one or two spectra. Depending on the nature and extent of the use of these results, these additional chemical shifts can be added to the calculations at any later date. However, in general, this change would have no effect on the results discussed below.

Statistical Analyses

The chemical shift intensity data for the selected resonances as described above were analyzed statistically using Hierarchical Cluster Analysis, (HCA); Principal Cluster Analysis (PCA); Robust Principal Components Analysis (RAPCA), Fuzzy k-nearest Neighbour analysis (Fuzzy KNN) and Kohonen neural network (self-organizing feature map) (SOFM).

In addition to the comparison of liver oils vs feed oils, the following pair of samples were of interest for comparison:
Sample 3 vs. Sample 6
Sample 4 vs. Sample 8
Sample 1 vs. Samples 7 and 8
Sample 2 vs. Samples 6 and 7
Sample 2 vs. Sample 9
   Results

Statistical analysis of data obtained in the present study resulted in very similar pictures. Evident differences were found between the liver oils and the oil blends that were used in the fish feed. For simplicity reasons a dendrogram from a Hierarchical Cluster Analysis is included to illustrate the general picture from the analysis carried out. As illustrated in FIG. 1 the samples 1-5 and 10 are all clustered together whereas the samples 6, 7, 8 and 9 all fall in separate clusters.

As described above all of the statistical analysis showed that the cod liver oil samples were different from the feed oil blends. Furthermore, it was possible to separate the different cod liver oils and feed oils produced and point to some factors responsible for the noted differences. The methods PCA, RAPCA and SOFM were used to obtain indications of which chemical shifts were responsible for the differences among samples.

NMR makes it possible to study intact fat extracts/marine oils directly without additional chemical treatment such as that required, for example, with GC and thin-layer chromatography. In the present study, ¹³C NMR was used to observe spectra/signals from carbons in all components found in oil samples. ¹³C-NMR spectra of a sample gives at the same time information on fat class, fatty acid profiles and how the fatty acids are esterified in triglyceride molecules (positional distribution of fatty acids), in addition to fatty acids in mono-, di- and triglyceride forms. In this respect ¹³C-NMR spectra may be used to differentiate between samples where fatty acid analysis alone would be inconclusive.

Thus, it has been shown that ¹³C-NMR spectra can be used to detect changes caused by metabolic processing in the fish. Consequently, this method can be used to differentiate between the oil or oil blend fed to fish and the liver oil extracted from the fish, as well as differentiate between various liver oils from cod fed different diets. It was found that certain regions in the ¹³C NMR spectra are useful for this differentiation.

Conclusions

Based on the results of the statistical analysis the following conclusions could be drawn:
The samples (liver oils vs feed oils) are truly different when considering all the data/evidence/chemical shifts.
A qualitative and quantitative degree of difference can be found between the samples.
These differences are consistent among many different/diverse multivariate analysis methods, i.e., the differences/groupings are self-consistent even when applying many tests based on different algorithms.
Chemical shifts which are responsible for the observed differences can be selected and assigned a relative degree of importance to these various chemical shifts from various multivariate and statistical tests.
Specific functional group assignments can be made for the major chemical shift changes that are observed.

The main differences between the oil blend in the feed and the oil extracted from the cod liver were found to be differences in fat class, fatty acid profiles and how the fatty acids are esterified in triglyceride molecules (positional distribution of fatty acids).

In general, the fatty acid profile and the positional distribution profile have changed from the feed lipids to the composition/distribution in liver oil for all the pairs of samples (e.g. sample 3 vs. sample 6, sample 4 vs. sample 8, etc). The fatty acid profile in combination with the positional distribution of the fatty acids in the glycerol molecule, is unique for each oil studied. The metabolic activity in liver results in increased amount of long chain monounsaturated fatty acids (20:1 and 22:1) often in the 1,3-position of the glycerol molecule. Research has shown a general tendency of 20:5n-3, 22:5n-3 and 22:6n-3 to preferentially esterified at the 2-position in fish triglyceride. The positional distribution of 22:6n-6 has some relation to the amounts of 20:1/22:1 fatty acids in fish triglycerides.

### REFERENCES

Lambertsen, G. and Braekkan, G. R., 1985. The fatty acid composition of cod liver oil. Fisk. Dir. Skr. Tekn. Undr. 4 No 11 (Directorate of Fisherires, Bergen, Norway).
Lie, Ø., Lied, E., and Lambertsen, 1986. Liver retention of fat and fatty acids in cod (Gadus morhua) fed different oils. Aquaculture, 59:187-196.
Lie, Ø., Lied, E., and Lambertsen, 1988. Feed optimization in Atlantic cod (Gadhus morhua): Fat versus protein content in the feed. Aquaculture, 69:333-341.
McEvoy, L. A., Estevez, A., Bell, J. G., Shields, R. J, Gara B. and Sargent, J. R., 1998. Influence of Dietary levels of eicosapentaenoic and arachidonic acid on the pigmentation success of turbot (Scopthalamus maximus) and (Hippoglossus hippoglossus). Bull. Aquacult. Assoc. Canada, 4:17-20.

1.-50. (canceled)

51. A method of making a fish composition comprising:
providing a feed composition that comprises at least one fatty acid to a fish that stores a fatty acid in their liver so as to obtain an altered amount of at least one fatty acid in said fish; and
extracting an oil from the liver of said fish that has been provided said composition, wherein said oil comprises an amount of Arachidonic acid that is at least 1 wt % of the total amount of fatty acids in said oil.

52. The method of claim 51, wherein the at least one fatty acid is a polyunsaturated fatty acid.

53. The method of claim 51, wherein the at least one fatty acid is a saturated fatty acid.

54. The method of claim 51, wherein said feed composition comprises the same fatty acid as the fatty acid that is altered in amount in said fish.

55. The method of claim 51, wherein said feed composition comprises a fatty acid that is different than the fatty acid that is altered in amount in said fish.

56. The method of claim 51, wherein said feed composition comprises Arachidonic acid.

57. The method of claim 51, wherein the at least one fatty acid comprises an omega-3 or an omega-6 polyunsaturated fatty acid.

58. The method of claim 51, wherein said feed composition comprises a fatty acid selected from the group consisting of Arachidonic acid, Eicosapentaenoic acid, and Docosahexaenoic acid.

59. The method of claim 51, wherein said feed composition comprises a fatty acid selected from the group consisting of caprylic acid (C8:0), capric acid (C10:0), and lauric acid (C12:0).

60. The method of claim 51, wherein said feed composition comprises a component selected from the group consisting of a free fatty acid, a glycerol ester of a fatty acid, a triglyceride, a fat fraction of an animal feed, a fat fraction of a food, a fish oil, a vegetable oil, a microbial oil, a microbial cell, a portion of a cell, and a fermentation broth.

61. The method of claim 51, wherein said oil comprises an amount of Eicosapentaenoic acid that is at least 10 wt % of the total amount of fatty acids in said oil.

62. The method of claim 51, wherein said oil comprises an amount of Docosahexaenoic acid that is at least 15 wt % of the total amount of fatty acids in said oil.

63. The method of claim 51, wherein said oil comprises an amount of Arachidonic acid that is at least 2 wt % of the total amount of fatty acids in said oil and an amount of Docosahexaenoic acid that is at least 15 wt % of the total amount of fatty acids in said oil.

64. The method of claim 51, wherein said oil comprises an amount of Eicosapentaenoic acid that is at or below 10 wt % of the total amount of fatty acids in said oil.

65. The method of claim 51, wherein said feed composition comprises an amount of Arachidonic acid that is at least 2 wt % of the total amount of fatty acids in the fat portion of said composition, an amount of Eicosapentaenoic acid that is at least 7 wt % of the total amount of fatty acids in the fat portion of said feed composition, or an amount of Docosahexaenoic acid that is at least 9 wt % of the total amount of fatty acids in the fat portion of said feed composition.

66. The method of claim 51, wherein said feed composition comprises an amount of Arachidonic acid that is at least 5 wt % of the total amount of fatty acids in the fat portion of said feed composition.

67. The method of claim 51, wherein said feed composition comprises an amount of Arachidonic acid that is at least 10 wt % of the total amount of fatty acids in the fat portion of said feed composition.

68. The method of claim 51, wherein said feed composition comprises an amount of Eicosapentaenoic acid that is at least 15 wt % of the total amount of fatty acids in the fat portion of said feed composition or an amount of Docosahexaenoic acid that is at least 9 wt % of the total amount of fatty acids in the fat portion of said feed composition.

69. The method of claim 51, further comprising:
(a) determining the amount of at least one fatty acid in said oil;
(b) adjusting the amount of a fatty acid in said feed composition in response to the amount of said at least one fatty acid determined in (a) so as to obtain an adjusted feed composition;
(c) providing a fish said adjusted feed composition; and
(d) repeating steps a-c.

70. The method of claim 51, wherein the amount of Arachidonic acid in said oil is at least 1.5 wt %, 2 wt %, 3 wt %, 5 wt %, 7 wt %, 10 wt %, 15 wt %, 20 wt % or 30 wt % of the total amount of fatty acids in said oil.

71. The method of claim 51, wherein said oil comprises an amount of omega-3 fatty acid that is at least 26 wt %, 28 wt %, 30 wt %, 32 wt %, 34 wt %, 36 wt %, or 40 wt % of the total amount of fatty acids in said oil.

72. The method of claim 51, wherein the amount of at least one fatty acid in the oil is higher than the amount of said fatty acid in an oil obtained from the same species of fish prior to feeding said fish with said feed composition.

73. The method of claim 51, wherein said fish is provided said feed composition for at least 6 weeks, 12 weeks, 25 weeks, or 2 years.

74. The method of claim 51, wherein said feed composition comprises at least 5 wt %, 10 wt %, 15 wt %, 20 wt %, 25 wt %, or 30 wt % fat.

75. The method of claim 51, wherein said fish belongs to the Gadidae species.

76. The method of claim 51, further comprising isolating a triglyceride from said fish.

77. The method of claim 51, further comprising formulating said fish composition for an infant formula.

78. An oil obtainable by the method of claim 51.

79. A composition comprising a fish oil that comprises an amount of Arachidonic acid that is at least 1 wt % of the total amount of fatty acids in said oil, an amount of Eicosapentaenoic acid that is at least 10 wt % of the total amount of fatty acids in said oil, or an amount of Docosahexaenoic acid that is at least 15 wt % of the total amount of fatty acids in said oil.

80. The composition of claim 79, wherein said fish belongs to the Gadidae species.

81. The composition of claim 79, wherein the amount of Arachidonic acid in said oil is at least 1.5 wt %, 2 wt %, 3 wt %, 5 wt %, 7 wt %, 10 wt %, 15 wt %, 20 wt % or 30 wt % of the total amount of fatty acids in said oil.

82. The composition of claim 79, wherein the amount of Docosahexaenoic acid in said oil is at least 17 wt %, 18 wt %, 19 wt %, 20 wt %, or 21 wt % of the total amount of fatty acids in said oil.

83. The composition of claim 79, wherein the amount of Eicosapentaenoic acid in said oil is at least 11 wt %, 12 wt %, or 13 wt % of the total amount of fatty acids in said oil.

84. The composition of claim 79, wherein the amount of omega-3 fatty acid in said oil is at least 26 wt %, 28 wt %, 30 wt %, 32 wt %, 34 wt %, 36 wt %, or 40 wt % of the total amount of fatty acids in said oil.

85. The composition of claim 79, wherein the ratio of Docosahexaenoic acid to Arachidonic acid is at least 0.2, 0.3-1.0, or 0.5-0.75 and the amount of Eicosapentaenoic acid is below 10 wt % of the total amount of fatty acids in said oil.

86. The composition of claim 79, further comprising a fatty acid or triglyceride of an animal, vegetable, or microbial origin.

87. The composition of claim 79, wherein said composition is a nutraceutical, a dietary supplement, a functional food ingredient, a food additive, or a feed additive.

88. The composition of claim 79, wherein said composition is an infant formula.
